(19) United States
(12) Patent Application Publication
(10) Pub. No.: US 2021/0061164 A1
(43) Pub. Date: Mar. 4, 2021

(54) SYSTEM AND METHOD FOR ILLUMINATING A PATH FOR AN OBJECT BY A VEHICLE

(71) Applicant: Toyota Connected North America, Inc., Plano, TX (US)

(72) Inventor: Brian M. Kursar, Fairview, TX (US)

(21) Appl. No.: 16/552,432

(22) Filed: Aug. 27, 2019

(51) Int. Cl. B60Q 1/08; B60Q 1/14; B60Q 1/52; G06K 9/00

(52) U.S. Cl. CPC B60Q 1/085; B60Q 1/143; B60Q 1/1438; B60Q 2300/054; G06K 9/00805; B60Q 2300/112; B60Q 2300/45; B60Q 1/525

(57) ABSTRACT

A system for illuminating a path for an object by a vehicle includes one or more processors, a memory device, one or more lights, and one or more sensors. The memory device, one or more lights, and one or more sensors may be in communication with the one or more processors. The memory device may include an object detection module and an illumination module. The object detection module includes instructions that cause the one or more processors to identify a presence of the object based on the one or more signals generated by the one or more sensors and determine object movement information of the object based on the one or more signals generated by the one or more sensors. The illumination module includes instructions that cause the one or more processors to illuminate using the one or more lights an area for the object based on the object movement information.

### TECHNICAL FIELD

The subject matter described herein relates, in general, to systems and methods for illuminating a path for an object by a vehicle.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Objects, such as pedestrians, traveling at night or in a darkened location, such as a tunnel, may rely on external lights that provide some illumination to assist the pedestrian with being able to see the environment around them. These external lights could include traditional street lamps, lighting embedded into nearby structures, or lighting from a portable device, such as a flashlight or mobile phone.

Some vehicles traveling near pedestrians may utilize one or more lighting systems to assist the drivers of these vehicles with seeing the environment around them, including objects such as pedestrians. While the light emitted from the vehicle assists the driver with seeing the environment around the vehicle, the light emitted by the vehicle may not necessarily help the pedestrian see the environment around them.

### SUMMARY

This section generally summarizes the disclosure and is not a comprehensive explanation of its full scope or all its features.

In one embodiment a method for illuminating a path for an object by a vehicle having one or more lights includes the steps of identifying a presence of an object, determining object movement information of the object, and illuminating an area for the object based on the object movement information.

In another embodiment, a system for illuminating a path for an object by a vehicle includes one or more processors, a memory device, one or more lights, and one or more sensors. The memory device, one or more lights, and one or more sensors may be in communication with the one or more processors. The memory device may include an object detection module and an illumination module. The object detection module includes instructions that cause the one or more processors to identify a presence of the object based on the one or more signals generated by the one or more sensors and determine object movement information of the object based on the one or more signals generated by the one or more sensors. The illumination module includes instructions that cause the one or more processors to illuminate using the one or more lights an area for the object based on the object movement information.

In yet another embodiment, the a non-transitory computer-readable medium for illuminating a path for an object by a vehicle having one or more lights includes instructions that when executed by one or more processors cause the one or more processors to identify a presence of an object, determine object movement information of the object, and illuminate an area for the object based on the object movement information

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented;

FIG. 2. illustrates one embodiment of a lighting control system that is associated with illuminating a path for an object by a vehicle having one or more lights;

FIG. 3. illustrates one example of two vehicles having a system for illuminating a path for objects, wherein the objects are pedestrians; and

FIG. 4 illustrates a method for illuminating a path for objects by a vehicle having one or more lights.

### DETAILED DESCRIPTION

Described are systems and methods for illuminating a path for objects by a vehicle having one or more lights. Moreover, the systems and methods may have the ability to determine when an object, such as a pedestrian, is near a vehicle. Once it is determined that an object is near a vehicle, object movement information regarding the object is then derived based on measurements obtained from one or more sensors. This object movement information could include information relating to the speed, location, and direction of the object. Based on the object movement information, one or more lights of the vehicle may be utilized to illuminate a path for the object to allow the object the ability to better see the surrounding environment.

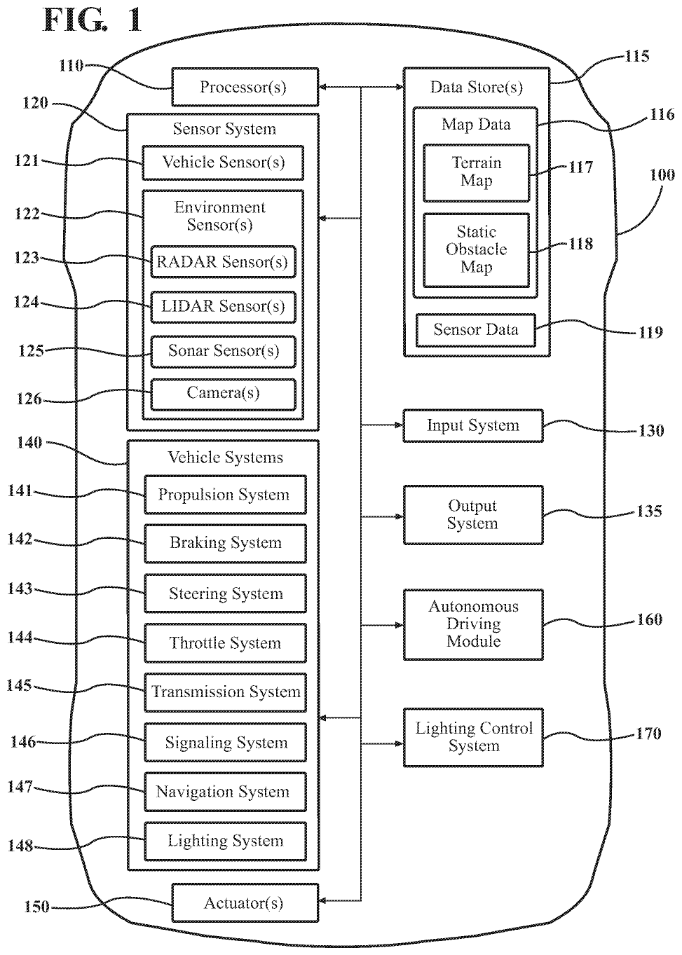

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

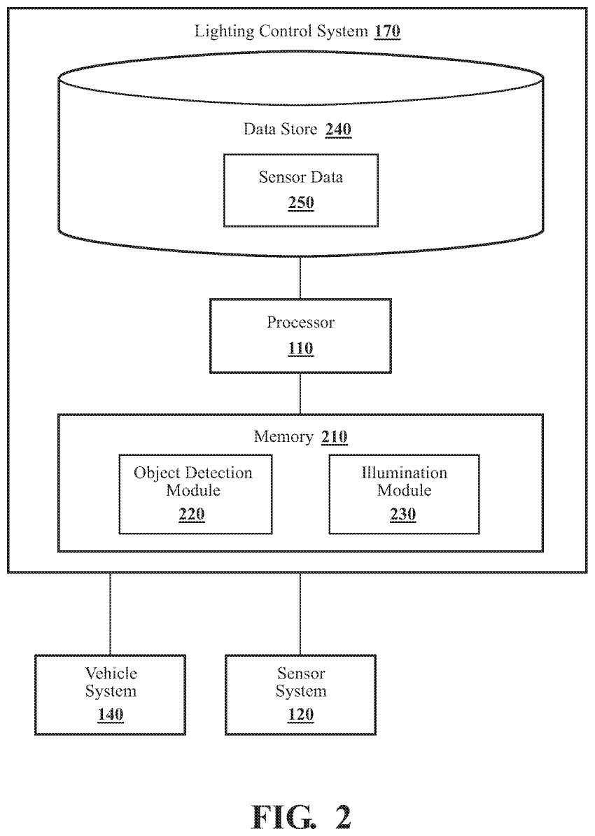

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the vehicle 100 includes a lighting control system 170. The lighting control system 170 may be able to determine when an object external to the vehicle 100 is present based on information received from the sensor system 120. If an object is external to the vehicle 100, the lighting control system 170 may determine object movement information related to the object that is external to the vehicle 100. The object movement information could include the location, speed, and/or direction of the object. Based on this object movement information, the lighting control system 170 may instruct a lighting system 148 which may include one or more lights for the vehicle 100 to illuminate an area or path on or around the object external to the vehicle 100. By so doing, the object external to the vehicle 100 will have additional light to allow the object external to the vehicle 100 to see the surrounding environment.

With reference to FIG. 2, one embodiment of the lighting control system 170 is further illustrated. As shown, the lighting control system 170 includes a processor 110. Accordingly, the processor(s) 110 may be a part of the lighting control system 170 or the lighting control system 170 may access the processor(s) 110 through a data bus or another communication path. In one or more embodiments, the processor(s) 110 is an application specific integrated circuit that is configured to implement functions associated with an object detection module 220 and an illumination module 230. In general, the processor(s) 110 is an electronic processor such as a microprocessor that is capable of performing various functions as described herein. In one embodiment, the lighting control system 170 includes a memory 210 that stores the object detection module 220 and the illumination module 230. The memory 210 is a random-access memory (RAM), read-only memory (ROM), a hard disk drive, a flash memory, or other suitable memory for storing the modules 220 and 230. The modules 220 and 230 are, for example, computer-readable instructions that when executed by the processor(s) 110 cause the processor(s) 110 to perform the various functions disclosed herein.

Furthermore, in one embodiment, the lighting control system 170 includes a data store 240. The data store 240 is, in one embodiment, an electronic data structure such as a database that is stored in the memory 210 or another memory and that is configured with routines that can be executed by the processor(s) 110 for analyzing stored data, providing stored data, organizing stored data, and so on. Thus, in one embodiment, the data store 240 stores data used by the modules 220 and 230 in executing various functions. In one embodiment, the data store 240 includes sensor data 250, along with, for example, other information that is used by the modules 220 and 230. The sensor data 250 may include some or all of the sensor data 119 shown in FIG. 1 and described later in this disclosure.

Accordingly, the object detection module 220 generally includes instructions that function to control the processor(s) 110 to identify a presence of the object based on the one or more signals generated by the one or more sensors. If an object is detected, the object detection module 220 may contain instructions to configure the processor(s) 110 to determine object movement information of the object based on the one or more signals generated by the one or more sensors. The object may be more than one object, such as a person walking their dog. As stated before, the object movement information could include the location, direction, and/or speed of the object.

Furthermore, the object detection module 220 may also include instructions that function to control the processor(s) 110 to determine vehicle movement information. The vehicle movement information relates to the vehicle 100 and may include information regarding the location, speed, and/or direction of the vehicle 100.

The illumination module 230 generally includes instructions that function to cause the processor(s) 110 to illuminate an area for the object based on the object movement information and/or vehicle movement information. The illumination of the area may be performed by one or more lights that form the lighting system 148. The one or more lights that form the lighting system 148 may include one or more types of lighting systems such as incandescent fluorescent, halogen, metal halide, light emitting diode, neon, and/or high-intensity discharge lighting {01152643} 5 systems. Furthermore, it should be understood that the light emitted by the lighting system may include light from the visible spectrum, as well as the invisible spectrum, such as infrared and ultraviolet light.

The one or more lights that form the lighting system 148 may be able to be adjusted based on one or more lighting parameters. These lighting parameters could include a beam angle, a beam size, and/or a beam intensity of the one or more lights. As such, the lighting system 148 may constantly adjust the beam angle, beam size, and/or beam intensity of the one or more lights to appropriately illuminate an area or path including or near the object based on the object movement information and/or vehicle movement information.

The area to be illuminated by the lighting system 148 may include the object or may be nearby the object. For example, the area to be illuminated could take into account the speed, location, and/or direction of the object to illuminate an area that the object appears to be moving towards. By so doing, the object can then see the environment, such as the ground, for any impediments that may impact the movement of the object before the object reaches those impediments. Additionally or alternatively, the area illuminated by the lighting system 148 may include the area surrounding the object. It should be understood that any one of several different mechanisms for determining the most appropriate illumination for the benefit of the object could be utilized. As such, it should be understood that the areas to be illuminated could include the object itself, an area that includes the object, or an area that the object is moving towards and/or away from or some combination thereof.

The illumination module 230 may also include instructions that function to control the processor(s) 110 to determine if the object is within the maximum throw of the lighting system 148. For example, if the object is beyond the maximum throw of the lighting system 148, the illumination module 230 may determine that the lighting system 148 will not be able to provide an appropriate amount of light to benefit the object and therefore may decide not to utilize the lighting system 148 to provide illumination for the object. On the other hand, if the object is within the maximum throw of the lighting system 148, the illumination module 230 may instruct the lighting system 148 to illuminate an area in or around the object.

Additionally, the illumination module 230 may also include instructions that function to control the processor(s) 110 to determine if an area or path near the object is already being illuminated by another vehicle. If such a case arises, the illumination module 230 may decide to provide additional lighting to the area or path near the object or, alternatively, decide not to provide any additional lighting as the lighting provided to the area or path may be deemed to be sufficient.

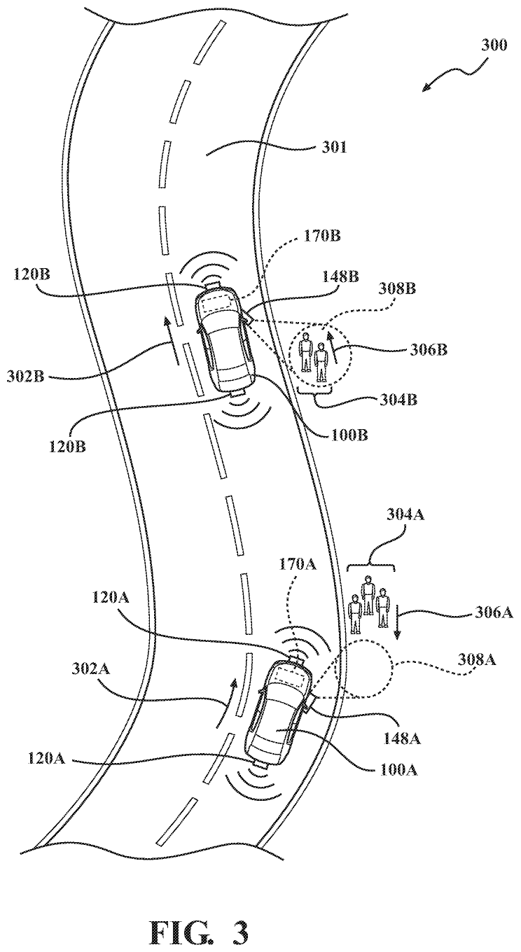

Referring to FIG. 3, an example 300 of vehicles 100A and 100B incorporating vehicle lighting systems 170A and 170B, respectively, will be described. It should be understood that the example 300 is merely an example to provide a better understanding of the vehicle lighting system 170 described in FIGS. 1 and 2. Therefore, it should be understood that the example 300 could include any number of vehicles or any number of objects.

Here, the example 300 includes a roadway 301 wherein vehicles 100A and 100B are traveling thereon. Vehicle 100A includes a vehicle lighting system 170A, while vehicle 100B includes vehicle lighting system 170B. The vehicles 100A and 100B may be similar to the vehicle 100 shown in FIG. 1. Furthermore, the vehicle lighting systems 170A and 170B may be similar to the vehicle lighting system 170 previously described.

The vehicles 100A and 100B also include sensor systems 120A and 120B, respectively. The sensor systems 120A and 120B may be similar to the sensor system 120 of FIG. 1. As such, the sensor systems 120A and/or 120B may include any one of several different sensors, such as those shown and described in FIG. 1. The sensor systems 120A and 120B allow the lighting systems 170A and 170B of vehicles 100A and 100B, respectively, to determine the presence of objects. For example, sensor system 120A may have the ability to determine the presence of objects, such as pedestrians 304A. It should be understood that the object may be any type of object and may include more than one object. As such, in this example, the object 304A includes three pedestrians. The lighting system 170A is capable of receiving information from the sensor system 120A regarding the object movement of the object 304A. The movement information of the object 304A, illustrated by arrow 306A, may include the location, speed, and/or direction of the object 304A.

Based on the object movement information 306A of the object 304A, the vehicle lighting system 170A is configured to determine an appropriate area or path 308A to illuminate. The illumination of this area or path 308A may be done by the vehicle lighting system 148A, which may include one or more lights. The lighting control system 170A instructs the lighting system 148A to illuminate an area or path 308A based on the object movement information 306A. The lighting system 148A may be able to adjust the beam size, beam angle, and/or beam intensity emitted by the lights of the lighting system 148A to constantly adjust and illuminate the appropriate area 308A for the benefit of the object 304A. In addition to using the object movement information 306A, the lighting system 170A may also utilize vehicle movement information, represented by arrow 302A. The vehicle movement information 302A may include the location, speed, and direction of the vehicle 100A. As such, the vehicle lighting system 170A can adjust the area of 308A to be illuminated based on both the vehicle movement information 302A and the object movement information 306A.

The area or path 308A to be illuminated can be determined by any one of several different methodologies. Moreover, as shown in this example, the area or path 308A is located forward of the object 304A and is essentially a location that the object 304A may be traveling to and/or through. Furthermore, as the object 304A moves, the area or path 308A to be illuminated may move as well. As such, the lighting system 148A may have to adjust not only for the movement of the object 304A but also for the movement of the vehicle 100A to illuminate the area 308A that benefits the object 304A.

The vehicle 100B may contain elements similar to that of vehicle 100A. Like reference numerals have been utilized to refer to like elements and therefore these elements will not be described again, as the previous description is equally applicable here. Here, the object 304B are two separate pedestrians that are traveling in a direction that may be similar to the direction of travel by the vehicle 100B. The area 308B illuminated by the lighting system 148B includes the objects 304B, which may be to pedestrians. This example also illustrates that the lighting system 148B may be able to change the angle projection to illuminate the area 308B even as the vehicle 100B passes the objects 304B. As such, lighting systems 148A and/or 148B can provide illumination to objects that are forward, besides, or behind the vehicles 100A and/or 100B.

It should be further noted that in the example 300, the lighting systems 148A and/or 148B are located on a side of the vehicles 100A and 100B, respectively. However, the lighting systems 148A and/or 148B may include numerous lighting systems that are located in different areas of the vehicles 100A and/or 100B. As such, it should be understood that the placement of lighting systems 148A and/or 148B is merely an example. In some situations, it may be advisable to mount the vehicle lighting system on a passenger side of the vehicle 100A and/or 100B to be closest to a side of the roadway 301 that is most likely to be populated with one or more objects, such as pedestrians 304A and/or 304B.

Additionally or alternatively, the lighting systems 170A and 170B of the vehicles 100A and 100B may work together to illuminate one or more areas for the benefit of one or more objects. For example, the vehicles 100A and/or 100B may each be able to communicate with each other by utilizing a V2X communication system 180. The V2X communication system 180 allows the vehicles 100A and/or 100B and any systems or subsystems disposed in the vehicles 100A and/or 100B to communicate with each other using one or more different wireless methodologies. As such, this allows for the lighting systems 170A and 170B to share information and coordinate the illumination of an area or path for the benefit of one or more objects. For example, the lighting system 148A of vehicle 100A may also be utilized to illuminate the area 308B or an area nearby or adjacent to the area 308B. By so doing, the objects 304B and benefit from illumination provided not by just one vehicle, but multiple vehicles.

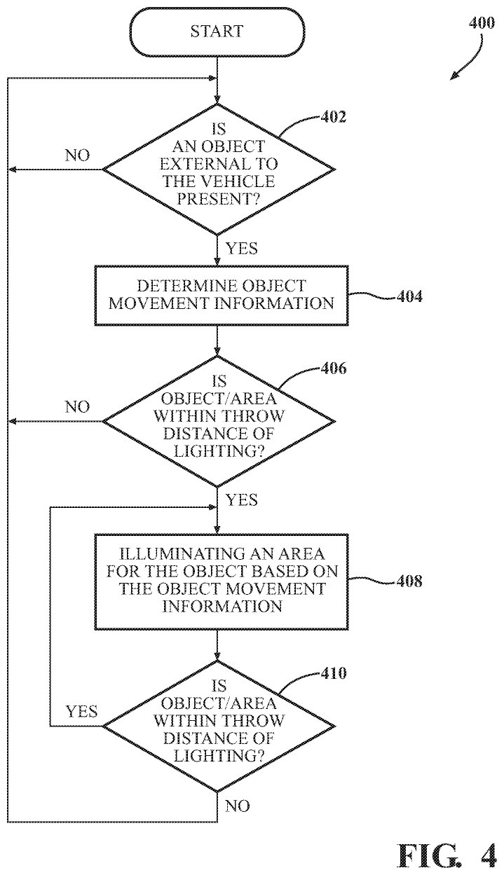

Referring to FIG. 4, a method 400 for illuminating a path for an object by a vehicle having one or more lights is shown. The method 400 will be described from the viewpoint of the vehicle 100 of FIG. 1 and the lighting control system 170 of FIG. 2. However, it should be understood that this is just one example of implementing the method 400. While the method 400 is discussed in combination with the lighting control system 170, it should be appreciated that the method 400 is not limited to being implemented within the lighting control system 170 but is instead one example of a system that may implement the method 400.

In step 402, the object detection module 220 may cause the processor(s) 110 to determine if an object external to the vehicle 100 is present. Here, the object detection module 220 may instruct the processor(s) 110 to receive information from the sensor system 120. Based on the information received from the sensor system 120, the processor(s) 110 can determine if an object is present. As stated before, the object may be any object external to the vehicle, such as a pedestrian, animal another vehicle, and the like. Furthermore, the object may include multiple objects, such as multiple pedestrians, animals, vehicles, or combinations thereof, and the like If an object is not detected, the method 400 either ends or returns to step 402.

If an object is detected, the method 400 proceeds to step 404. At step 404, the object detection module 220 may cause the processor(s) 110 to determine object movement information. The object movement information may be determined based on the signals received from the sensor system 120. The object movement information could include the location, speed, and/or direction of the object. Additionally or alternatively, the object detection module 220 may also cause the processor(s) 110 to determine the vehicle movement information regarding the vehicle 100. The vehicle movement information could include the location, speed, and/or direction of the vehicle.

In step 406, the method 400 determines if the object is within a throw distance of one or more lights of the vehicle 100. Here, the illumination module 230 may cause the processor(s) 110 to determine the distance between the vehicle 100 and the object and determine if this distance is greater than the throw distance of the one or more lights that form the lighting system 148. If the object is not within the throw one or more lights that form the lighting system 148, the method 400 returns to step 402.

However, if the object is within the throw distance of one or more lights that form the lighting system 148, the method 400 proceeds to step 408. In step 408, the illumination module 230 may cause the processor(s) 110 to illuminate an area for the object based on the object movement information. Additionally or alternatively, the illumination module 230 may cause the processor(s) 110 to illuminate an area for the object based on the object movement information and/or the vehicle movement information.

The method 400 may also include step 410, which determines if the object or an area to be illuminated is still within the throw distance of the one or more lights that form the lighting system 148. Here, the purpose of step 410 is to eventually determine when the detected object or area to be illuminated is no longer within the throw distance of the vehicle 100. If the object or area to be illuminated is outside the throw distance of the lighting system 148, the method returns to step 402 and begins again. However, if the object or area to be illuminated is within the throw distance of the lighting system 148, the method returns to step 408, wherein the lighting system 148 illuminates an area for the object based on the object movement information and/or the vehicle movement information.

FIG. 1 will now be discussed in full detail as an example environment within which the system and methods disclosed herein may operate. In one or more embodiments, the vehicle 100 may be an autonomous vehicle, semi-autonomous, or non-autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110 and/or the lighting control system 170 can be operatively connected to communicate with the various vehicle systems 140 and/or individual components thereof. For example, returning to FIG. 1, the processor(s) 110 and/or the lighting control system 170 can be in communication to send and/or receive information from the various vehicle systems 140 to control the movement, speed, maneuvering, heading, direction, etc. of the vehicle 100. The processor(s) 110 and/or the lighting control system 170 can be operatively connected to communicate with the various vehicle systems 140 and/or individual components thereof.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the lighting control system 170. Any suitable actuator can be used. For instance, the one or more actuators 150 can include motors, pneumatic actuators, hydraulic pistons, relays, solenoids, and/or piezoelectric actuators, and one or more lights just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for illuminating a path for an object by a vehicle having one or more lights, the method comprising the steps of:
identifying a presence of an object, wherein the object is external to the vehicle;
determining object movement information of the object; and
illuminating an area for the object based on the object movement information.

2. The method of claim 1, wherein the object movement information includes a location, direction and speed of the object.

3. The method of claim 1, further comprising the step of illuminating the area for the object based on object movement information and vehicle movement information.

4. The method of claim 3, wherein the object movement information and the vehicle movement information includes a location, direction and speed of the vehicle and the object.

5. The method of claim 1, further comprising the steps of:
determining a throw distance of the one or more lights of the vehicle; and
illuminating the area for the object when the throw distance is less than a distance between the object and the vehicle.

6. The method of claim 1, further comprising the step of adjusting a light parameter of the one or more lights of the vehicle based on the object movement information.

7. The method of claim 6, wherein the light parameter for the one or more lights includes one or more of a beam angle of the one or more lights, a beam size of the one or more lights, and a beam intensity of the one or more lights.

8. The method of claim 1, further comprising the steps of:
determining when the area for the object is being illuminated by another vehicle having one or more lights; and
illuminating the area for the object based on the object movement information and if another vehicle having one or more lights is illuminating the area.

9. A system for illuminating a path for an object by a vehicle, the system comprising:
one or more processors;
one or more lights in communication with the one or more processors;
one or more sensors in communication with the one or more processors, the one or more sensors configured to detect the object and generate one or more signals based on a detection of the object;
a memory device in communication with the one or more processors, the memory device comprising an object detection module having instructions that when executed by the one or more processors cause the one or more processors to identify a presence of the object based on the one or more signals generated by the one or more sensors and determine object movement information of the object based on the one or more signals generated by the one or more sensors; and
the memory device further comprising an illumination module, the illumination module having instructions that when executed by the one or more processors cause the one or more processors to illuminate using the one or more lights an area for the object based on the object movement information.

10. The system of claim 9, wherein the object movement information includes a location, direction and speed of the object.

11. The system of claim 9, wherein the illumination module having instructions that when executed by the one or more processors further cause the one or more processors to illuminate the area for the object based on object movement information and vehicle movement information.

12. The system of claim 11, wherein the object movement information and the vehicle movement information includes a location, direction and speed of the vehicle and the object.

13. The system of claim 9, wherein the illumination module having instructions that when executed by the one or more processors further cause the one or more processors to:
determine a throw distance of the one or more lights of the vehicle; and
illuminate using the one or more lights the area for the object when the throw distance is less than a distance between the object and the vehicle.

14. The system of claim 9, wherein the illumination module having instructions that when executed by the one or more processors further cause the one or more processors to adjust a light parameter of the one or more lights of the vehicle based on the object movement information.

15. The system of claim 14, wherein the light parameter for the one or more lights includes one or more of a beam angle of the one or more lights, a beam size of the one or more lights, and a beam intensity of the one or more lights.

16. The system of claim 9, wherein the system is mounted within a vehicle.

17. The system of claim 9, wherein the illumination module having instructions that when executed by the one or more processors further cause the one or more processors to:
determine when the area for the object is being illuminated by another vehicle having one or more lights; and
illuminate the area for the object based on the object movement information and if another vehicle having one or more lights is illuminating the area.

18. A non-transitory computer-readable medium for illuminating a path for an object by a vehicle having one or more lights, the non-transitory computer-readable medium comprising instructions that when executed by one or more processors cause the one or more processors to:
identify a presence of an object, wherein the object is external to the vehicle;
determine object movement information of the object; and
illuminate an area for the object based on the object movement information.

19. The non-transitory computer-readable medium of claim 18, wherein the object movement information includes a location, direction and speed of the object.

20. The non-transitory computer-readable medium of claim 18, further comprising instructions that when executed by one or more processors cause the one or more processors to illuminate the area for the object based on object movement information and vehicle movement information.
